(19) United States
(12) Patent Application Publication
(10) Pub. No.: US 2018/0120596 A1
(43) Pub. Date: May 3, 2018

(54) CONDUCTIVE HEATING PAINT COMBINED WITH THERMOCHROMIC PAINT TO CONTROL COLOR CHANGE

(71) Applicant: BEHR PROCESS CORPORATION, Santa Ana, CA (US)

(72) Inventors: JIANG YUNFEI, FOUNTAIN VALLEY, CA (US); GREGORY ALLEN WILLIAMS, LAGUNA BEACH, CA (US); LAN DUC LIANG, GARDEN GROVE, CA (US); KHANH-MINH CHU, WESTMINSTER, CA (US); MING-REN TARNG, IRVINE, CA (US)

(21) Appl. No.: 15/341,469

(22) Filed: Nov. 2, 2016

(51) Int. Cl. G02F 1/01; G02F 1/163; G02F 1/155; B05D 7/00

(52) U.S. Cl. CPC G02F 1/0147; B05D 7/50; G02F 1/155; G02F 1/163

(57) ABSTRACT

A multilayer coating that provides a switchable color includes a substrate, an electrically conductive heating paint layer disposed over the substrate, a non-electrically conductive paint layer disposed over the electrically conductive heating paint layer, and a thermochromic paint layer disposed over the non-electrically conductive paint layer. The non-electrically conductive paint layer has a base color at 25° C. The thermochromic paint layer has a first preset color at 25° C. and a second preset color at a switching temperature that is higher than 25° C. Characteristically, the first preset color is matched to the base color. A controllable voltage source is in communication with the electrically conductive heating paint layer to switch between a first preset color and a second preset color.

### TECHNICAL FIELD

In at least one embodiment, the present invention is related to multilayer paint structures that include a thermochromic layer.

### BACKGROUND

Paint coatings are ubiquitous finding numerous applications for both aesthetic and functional applications. In many applications, paint coatings are applied to improve the aesthetic appeal of a surface by providing a uniform and pleasing appearance. Moreover, in a competitive market such as the paint industry, paint layers having additional dynamic functionality such as the ability to switch color can provide a competitive edge.

Accordingly, there a need for paint coating structures with enhanced aesthetic appeal and the ability to switch color.

### SUMMARY

In at least one embodiment, the present invention solves one or more problems of the prior art by providing a multilayer coating with a switchable color. The multilayer coating includes a substrate, an electrically conductive heating paint layer disposed over the substrate, a non-electrically conductive paint layer disposed over the electrically conductive heating paint layer, and a thermochromic paint layer disposed over the non-electrically conductive paint layer. The non-electrically conductive paint layer has a base color at 25° C. The thermochromic paint layer has a first preset color at 25° C. and a second preset color at a switching temperature that is higher than 25° C. Characteristically, the first preset color is matched to the base color. A controllable voltage source is in communication with the electrically conductive heating paint layer to switch between a first preset color and a second preset color.

In another embodiment, a multilayer coating with a switchable color is provided. The multilayer coating includes a substrate, an electrically conductive heating paint layer disposed over the substrate, and a thermochromic paint layer disposed over the electrically conductive heating paint layer. The thermochromic paint layer has a first preset color at 25° C. and a second preset color at a first switching temperature that is higher than 25° C. The thermochromic paint layer also has at least one additional preset color that switches color at a temperature higher than the first preset color. A controllable voltage source is in communication with the electrically conductive heating paint layer to switch between a first preset color and a second preset color.

### BRIEF DESCRIPTION OF THE DRAWINGS

FIG. 1 is schematic illustration of a multilayer coating that includes a thermochromic layer with a switchable color;

FIG. 2 is a top view of the multilayer coating of FIG. 1 in which the thermochromic layer is patterned; and

FIG. 3 is schematic illustration of a multilayer coating that includes a thermochromic layer with multiple color transitions.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. When one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this invention pertains.

The term “dominant wavelength” refers to a way of describing polychromatic light mixtures in terms of monochromatic light that evokes an identical perception of hue. It is determined on the CIE color coordinate space by straight line the color coordinates for the color of interest and the coordinates for the illuminate. The intersection at the perimeter of the coordinate space nearest the color of interest is the dominant wavelength.

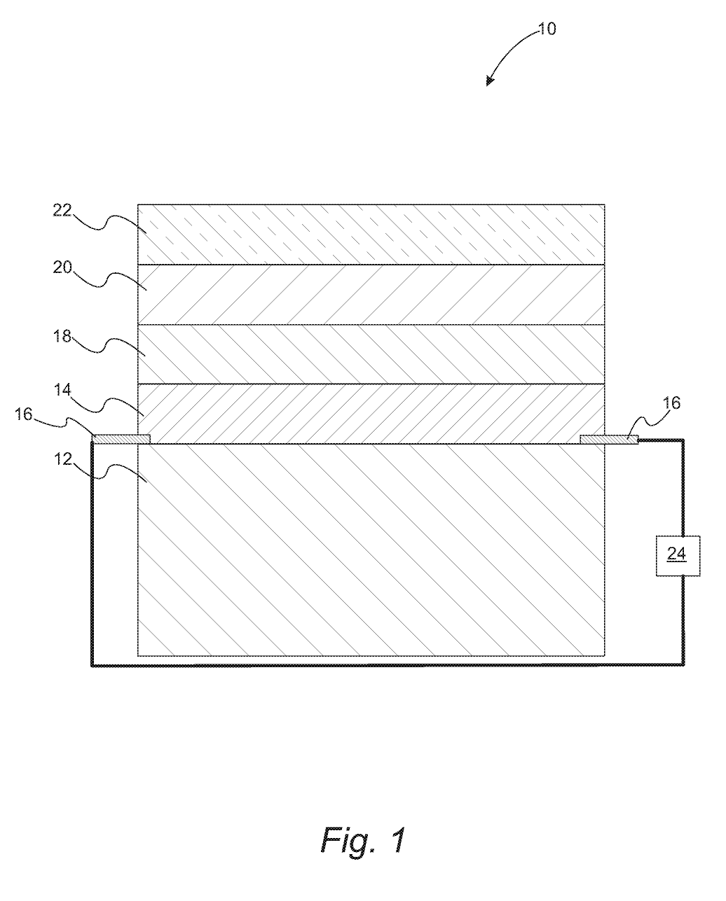

With reference to FIG. 1, a multilayer coating that provides a switchable color is provided. Multilayer coating 10 includes substrate 12 which is coated with an electrically conductive heating paint layer 14. Substrate 12 can be virtually any material that can be painted such as drywall, wood, plaster, plastic and the like. Electrically conductive heating paint layer is formed from an electrically conducting layer-forming paint composition. Such paint compositions can be latex or oil-based paint compositions that include electrically conductive particles such as metal particles (e.g., electrically conducting copper particles, silver coated copper pigments, and the like) and/or carbon particles (e.g., graphite particles/pigments, carbon nanotubes, and the like). Electrical contacts 16 are in electrical contact with electrically conductive heating paint layer 14. In a refinement, metal electrical contacts 16 are a thin metal layer (e.g., copper) which is adhered to substrate. In another refinement, electrical contacts 16 are an electrically conductive contact layer that is formed from an electrically conducting coating-forming ink or paint as set forth above.

Still referring to FIG. 1, a non-electrically conductive paint layer 18 having a base color is disposed over the electrically conductive heating paint layer 14. In this context, “base color” merely means the color exhibited by non-electrically conductive paint layer 18. Moreover, non-electrically conductive paint layer 18 has an electrical conductivity that is at most 10 percent of the conductivity of electrically conductive heating paint layer 14. Typically, the base color does not change over a temperature range from 0° C. to 180° C. Thermochromic paint layer 20 is disposed over the non-electrically conductive paint layer 18. In one variation, thermochromic layer 20 has a first preset color at room temperature (i.e., 25° C.) that matches the color of the base layer color. Characteristically, the first preset color is matched to the base color. In a variation, the first preset color is matched to the base color by being within the same class of colors (e.g., red colors, blue colors, purple colors, green colors, yellow colors, orange colors, and the like). In a refinement, the first preset color has a dominant wavelength that is within 20 percent of the dominant wavelength of the base color under a white illuminant. In another refinement, the first preset color has a dominant wavelength that is within 10 percent of the dominant wavelength of the base color under a white illuminant. In yet another refinement, the first preset color has a dominant wavelength that is within 5 percent of the dominant wavelength of the base color under a white illuminant. In still another refinement, the first preset color has a dominant wavelength that is within 2 percent of the dominant wavelength of the base color under a white illuminant. Examples of white illuminates for these comparisons are CIE Illuminant A, B, or C.

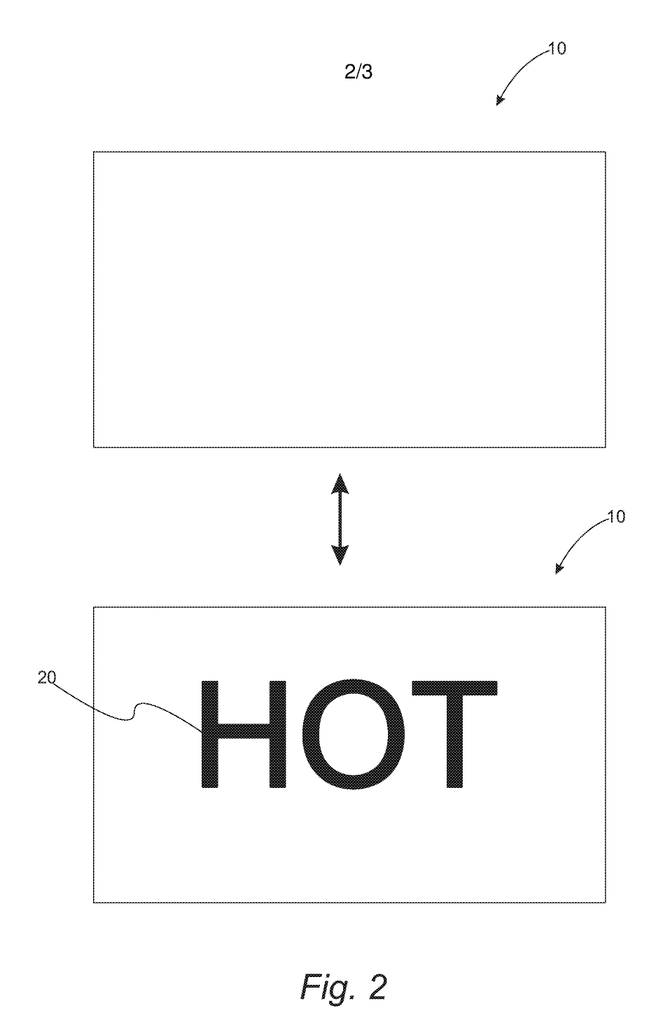

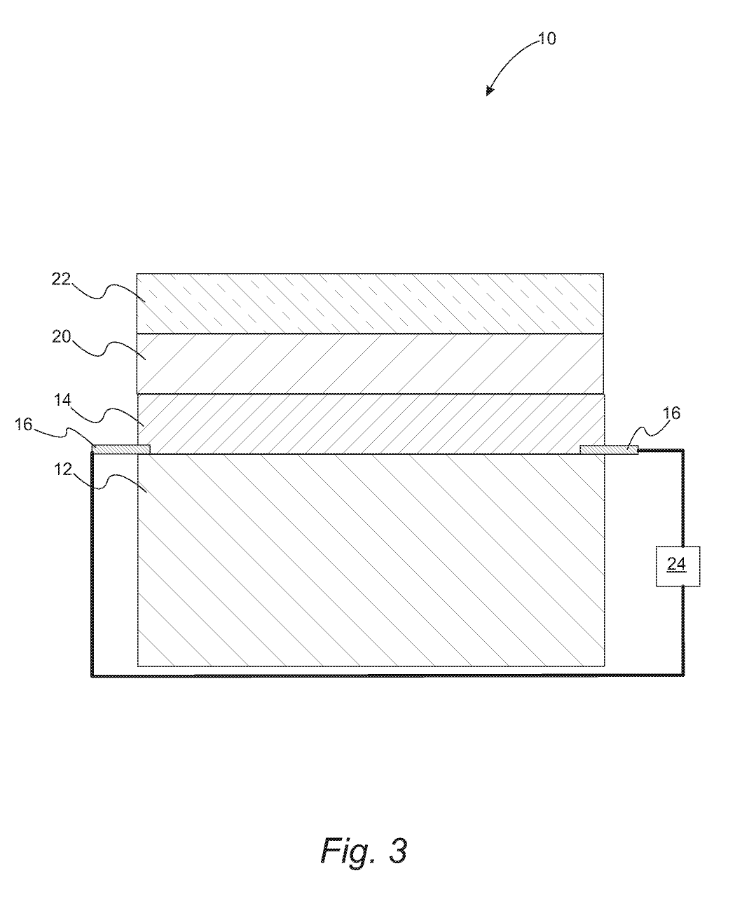

Thermochromic paint layer 20 also has at least one second preset color that is exhibited at a switching temperature that is greater than 25° C., 35° C., 40° C., 45° C., or 50° C. Typically, the switching temperature is less than, in increasing order of preference, 100° C., 80° C., 70° C., 65° C. or 60° C. In another variation, thermochromic paint layer 20 has multiple additional preset colors (e.g. 1, 2 or 3 additional present colors). Typically, the switching temperatures for each of second preset color and the additional preset colors will be at different temperature so that the color stage can be in stages by increasing the temperature as set forth below with respect to the description of FIG. 3. In a variation, thermochromic paint layer 20 need not completely cover non-electrically conductive paint layer 18. In another refinement, layers 18 and 20 can be combined into a single layer. Instead, thermochromic paint layer 20 can be patterned with, for example, a stencil when applied. Moreover, several regions of non-electrically conductive paint layer 18 can be coated with thermochromic paint layers exhibiting different second preset colors. Optionally, thermochromic layer is over-coated with clear coat layer 22. Controllable voltage source 24 is in communication with electrically conductive heating paint layer 14 to switch between a first preset color and a second preset color. In a refinement, controllable voltage source 24 applies a DC voltage to electrically conductive heating paint layer 14. The DC voltage can be from 1 volt to 20 volts or more. In another refinement, electrically conductive heating paint layer 14 applies an AC voltage to electrically conductive heating paint layer 14. The AC voltage can be from 1 to 20 volts or more. FIG. 2 is a top view of a substrate coated with the multilayer coating 10 of FIG. 1. In the variation of FIG. 2, thermochromic paint layer 20 is patterned such that when the layer is switched, the pattern is revealed.

With reference to FIGS. 1 and 2, in another variation, thermochromic layer 20 has a first preset color at room temperature (i.e., 25° C.) that that is different that the color of the base layer color. In a refinement, the first preset color has a dominant wavelength that is within greater than 10 percent of the dominant wavelength of the base color under a white illuminant. In another refinement, the first preset color has a dominant wavelength that is greater than 20 percent of the dominant wavelength of the base color under a white illuminant. In yet another refinement, the first preset color has a dominant wavelength that is greater than 30 percent of the dominant wavelength of the base color under a white illuminant. As set forth above, examples of white illuminates for these comparisons are CIE Illuminant A, B, or C. As set forth above, thermochromic paint layer 20 also has a second preset color that is exhibited at a switching temperature that is greater than 25° C., 35° C., 40° C., 45° C., or 50° C. Typically, the switching temperature is less than, in increasing order of preference, 100° C., 80° C., 70° C., 65° C. or 60° C. However, in this variation the second preset color will either be clear or will match the base color under a white illuminant. When the second preset color matches the base color, it will typically have a dominant wavelength that is within 20 percent of the dominant wavelength of the base color under a white illuminant. In another refinement, the second preset color has a dominant wavelength that is within 10 percent of the dominant wavelength of the base color under a white illuminant. In yet another refinement, the second preset color has a dominant wavelength that is within 5 percent of the dominant wavelength of the base color under a white illuminant. In still another refinement, the second preset color has a dominant wavelength that is within 2 percent of the dominant wavelength of the base color under a white illuminant.

With reference to FIG. 3, a multilayer coating that provides switchable colors is provided. Multilayer coating 10 includes substrate 12 which is coated with an electrically conductive heating paint layer 14. Substrate 12 can be virtually any material that can be painted such as drywall, wood, plaster, plastic and the like. Electrically conductive heating paint layer 14 is formed from an electrically conducting layer-forming paint composition. Such paint compositions can be latex or oil-based paint compositions that include electrically conductive particles such as metal particles (e.g., electrically conducting copper particles, silver coated copper, and the like) and/or carbon particles (e.g., graphite particles, carbon nanotubes, and the like). Electrical contacts 16 are in electrical contact with electrically conductive heating paint layer 14. In a refinement, metal electrical contacts 16 are a thin metal layer (e.g., copper) which is adhered to substrate. In another refinement, electrical contacts 16 are an electrically conductive contact layer that is formed from an electrically conducting coating-forming ink or paint as set forth above. Thermochromic paint layer 20 is disposed over electrically conductive heating paint layer 14. Optionally, thermochromic layer is over-coated with clear coat layer 22. In the present variation, thermochromic paint layer 20 has a first preset color at room temperature (i.e., 25° C.). Characteristically, thermochromic paint layer 20 has multiple additional preset colors (e.g., 2, 3 or 4 preset colors) which switch color at temperatures greater than 25° C. For example, thermochromic paint layer 20 can switch to a second preset color at a first switching temperature, to a third preset color at a second switching temperature, and optionally, to a fourth preset color at a third switching temperature. In this example, the first switching temperature, second switching temperature, and third switching temperature are progressively higher and each is greater than room temperature. Characteristically, the first switching temperature, second switching temperature, and third switching temperature are each independently greater than 25° C., 35° C., 40° C., 45° C., or 50° C. Typically, the first switching temperature, second switching temperature, and third switching temperature are each independently less than, in increasing order of preference, 120° C., 100° C., 80° C., 70° C. 65° C. or 60° C. A thermochromic layer that has such multiple color transitions can be achieved by incorporation of multiple thermochromic pigments into the thermochromic paint composition. Different regions of the electrically conductive paint layer can be coated with different thermochromic paint layers exhibiting different color transitions (e.g., second, third or fourth preset colors). Moreover, the thermochromic paint layer can be a patterned layer.

In a variation, the non-electrically conductive paint layer is formed from a non-electrically conductive paint composition. Similarly, the thermochromic paint layer is formed from a thermochromic paint composition. Characteristically, the non-electrically conductive paint composition and the thermochromic paint composition each independently include an acrylic resin and a solvent such as water. The resin can be an acrylic resin, styrene acrylic resin, polyvinyl alcohol, ethylene-vinyl acetate, silicon resin and the like. In a refinement, the acrylic resin is a solution polymer. In another refinement, the acrylic resin is an emulsion polymer. Suitable acrylic resins are formed from monomers selected from the group consisting of methacrylate, methyl acrylate, ethyl acrylate, 2-chloroethyl vinyl ether, 2-ethylhexyl acrylate, hydroxyethyl methacrylate, butyl acrylate, butyl methacrylate, trimethylolpropane triacrylate, pentafluorophenyl methacrylate, pentafluorophenyl acrylate, 1,1,1,3,3,3-hexafluoroisopropyl acrylate, bis-(2,2,2-trifluoroethyl) itaconate, bis-(1,1,1,3,3,3-hexafluoroisopropyl), 1H,1H,3H-hexafluorobutyl acrylate, 1H,1H,7H-dodecafluoroheptyl methacrylate, 2,2,2-trifluoroethyl acrylate, 2,2,2-trifluoroethyl methacrylate, aliphatic, fluorinated aliphatic, 1H,1H,2H,2H-Heptadecafluorodecyl methacrylate 532.2 acrylic, 1H, 1H,2H,2H-heptadecafluorodecyl acrylate, 1H,1H,5H-octafluoropentyl acrylate, 1H,1H,3H-tetrafluoropropyl methacrylate, hexafluoro-iso-propyl, 1H,1H,3H-hexafluorobutyl methacrylate, 1H,1H,5H-octafluoropentyl methacrylate, and combinations thereof. In a further refinement, the acrylic resin is a copolymer of the monomers set forth above. The acrylic resin is typically present in an amount of 50 to 95 percent of the dry weight of the non-electrically conductive paint composition or the thermochromic paint composition. In a refinement, the acrylic resin is present in an amount of 60 to 90 percent of the dry weight of the non-electrically conductive paint composition or the thermochromic paint composition.

Typically, the non-electrically conductive paint composition and the thermochromic paint composition each independently include one or more pigments. Suitable pigments are azo dyes, phthalocyanine, anthraquinone dyes, titanium oxide, calcium carbonate, iron oxides (black, yellow and red), zinc oxide and carbon black, powdered metals, metal compounds (e.g., zinc phosphate), and combinations thereof. In a refinement, the pigments are present in an amount from about 10 to 30 weight percent of the dry weight of the non-electrically conductive paint composition or the thermochromic paint composition. In a variation, the non-electrically conductive paint composition can include a matting agent to adjust the gloss to a lower sheen. The matting agent can be any extender pigment that does not add opacity to the clear coat, such as silicas, nepheline syenite, and the like. In a refinement, the matting agent is present in an amount from about 0.2 to 10 percent of the dry weight of the non-electrically conductive paint composition or the thermochromic paint composition.

In some variations, the non-electrically conductive paint composition or the thermochromic paint composition each independently includes one or more additives selected from the group consisting of rheology modifiers, surfactants, defoamers, organic solvents, pH adjusters, UV stabilizers, dispersants, coalescents, biocides, inorganic pigment, organic pigments, and combinations thereof. These additives are typically present in an amount from about 0.1 to 10 percent of the dry weight of the non-electrically conductive paint composition or the thermochromic paint composition.

The thermochromic paint composition includes a thermochromic pigment which is known in the art. Examples of such thermochromic pigments include, but are not limited to, leuco dyes (e.g., Vat dyes, sulfur dyes, and the like). The color of the thermochromic paint layer is formulated by a combination of the thermochromic pigments and the other pigments set forth above. In a refinement, the acrylic resin is present in an amount of 5 to 30 percent of the dry weight of the non-electrically conductive paint composition or the thermochromic paint composition. Specific examples of thermochromic pigments include MATSUI CHROMICOLOR, LCR HALLCREST THEROMOCHROMIC, and the like.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A multilayer coating that provides a switchable color, the multilayer coating comprising:
a substrate;
an electrically conductive heating paint layer disposed over the substrate;
a non-electrically conductive paint layer disposed over the electrically conductive heating paint layer, the non-electrically conductive paint layer having a base color at 25° C.;
a thermochromic paint layer disposed over the non-electrically conductive paint layer, the thermochromic paint layer having a first preset color at 25° C. and a second preset color at a switching temperature that is higher than 25° C., the first preset color being matched to the base color; and
a controllable voltage source in communication with the electrically conductive heating paint layer to switch between a first preset color and a second preset color.

2. The multilayer coating of claim 1 wherein the first preset color has a dominant wavelength that is within 20 percent of the dominant wavelength of the base color under a white illuminant.

3. The multilayer coating of claim 1 wherein the first preset color has a dominant wavelength that is within 10 percent of the dominant wavelength of the base color under a white illuminant.

4. The multilayer coating of claim 1 wherein the switching temperature is higher than 35° C.

5. The multilayer coating of claim 1 further comprising electrical contacts contacting the electrically conductive heating paint layer.

6. The multilayer coating of claim 1 wherein the electrically conductive heating paint layer includes electrically conductive carbon nanotubes (CNT) and/or graphite pigment.

7. The multilayer coating of claim 1 wherein the electrically conductive heating paint layer includes electrically conductive copper pigment and/or silver coated inorganic pigments.

8. The multilayer coating of claim 1 wherein the electrically conductive heating paint layer is formed from a latex paint.

9. The multilayer coating of claim 1 wherein the electrically conductive heating paint layer is formed from an oil-based paint.

10. The multilayer coating of claim 1 wherein different regions of the non-electrically conductive paint layer are coated with different thermochromic paint layers exhibiting different second preset colors.

11. The multilayer coating of claim 1 wherein the thermochromic paint layer is a patterned layer.

12. A multilayer coating that provides a switchable color, the multilayer coating comprising:
a substrate;
an electrically conductive heating paint layer disposed over the substrate;
a thermochromic paint layer disposed over the electrically conductive heating paint layer, the thermochromic paint layer having a first preset color at 25° C., a second preset color at a first switching temperature that is higher than 25° C., and at least one additional preset color at temperatures higher than the first switching temperature; and
a controllable voltage source in communication with the electrically conductive heating paint layer to switch among the first preset color, the second preset color, and the at least one additional preset color.

13. The multilayer coating of claim 12 wherein the at least one additional preset color includes a third preset color and a fourth preset color.

14. The multilayer coating of claim 12 wherein the first switching temperature is higher than 35° C.

15. The multilayer coating of claim 12 further comprising electrical contacts contacting the electrically conductive heating paint layer.

16. The multilayer coating of claim 12 wherein the electrically conductive heating paint layer includes electrically conductive carbon nanotubes (CNT) and/or graphite.

17. The multilayer coating of claim 12 wherein the electrically conductive heating paint layer includes electrically conductive copper pigment and/or silver coated inorganic pigments.

18. The multilayer coating of claim 12 wherein the electrically conductive heating paint layer is formed from a latex paint.

19. The multilayer coating of claim 12 wherein different regions of the electrically conductive heating paint layer are coated with different thermochromic paint layers exhibiting different color transitions.

20. The multilayer coating of claim 12 wherein the thermochromic paint layer is a patterned layer.
